(19) United States
(12) Patent Application Publication
(10) Pub. No.: US 2025/0039172 A1
(43) Pub. Date: Jan. 30, 2025

(54) IDENTIFICATION VERIFICATION

(71) Applicants: Joseph J. Ruzevich, Orland Park, IL (US); Joseph M. Ruzevich, Orland Park, IL (US)

(72) Inventors: Joseph J. Ruzevich, Orland Park, IL (US); Joseph M. Ruzevich, Orland Park, IL (US)

(21) Appl. No.: 18/807,181

(22) Filed: Aug. 16, 2024

Related U.S. Application Data
(60) Provisional application No. 63/529,513, filed on Jul. 28, 2023.

(51) Int. Cl. H04L 9/40

(52) U.S. Cl. CPC H04L 63/0861

(57) ABSTRACT

A system for verifying an identity includes a memory that stores instructions and a processor that executes the instructions. When executed, the instructions cause the system to: receive a first request to register an identity for a party; prompt the party to provide personal identification information and a first biometric sample; persistently associate the personal identification information with the first biometric sample as a biometric identity; receive a second request to complete a transaction with an electronic signature of the party based on the first biometric identity; prompt the party to provide the personal identification information and a second biometric sample; verify the personal identification information and the second biometric sample using the biometric identity; create a verification based on verifying the personal identification information and the second biometric sample; and persistently mark an electronic record of the transaction with the verification.

### CROSS-REFERENCE TO THE RELATED APPLICATION

This U.S. nonprovisional patent application claims the benefit of priority to Provisional U.S. Patent Application No. 63/529,513, filed on Jul. 28, 2023 in the United States Patent and Trademark Office, the contents of which are herein incorporated by reference in their entirety.

### BACKGROUND

Electronic documents may be signed using a signature image created dynamically or retrieved as an image from storage. The signature image may be created in graphic design software, captured from an image of a paper document, or selected from a variety of prefabricated signatures based on a user's legal name.

Separately, biometrics are sometimes used for identifying an individual. For example, some smartphones and smartphone applications or other services may register a fingerprint of a user in order to expedite subsequent access by the user. However, biometrics are not typically used in uncontrolled contexts, such as to dynamically enable access or complete a transaction from a user or party using an unrecognized device.

### SUMMARY

According to an aspect of the present disclosure, a system for verifying an identity includes a memory that stores instructions; and a processor that executes the instructions. When executed by the processor, the instructions cause the system to: receive a first request to register an identity for a first party; prompt the first party to provide first personal identification information and a first biometric sample; persistently associate the first personal identification information with the first biometric sample as a first biometric identity; receive a second request to complete a transaction with an electronic signature of the first party based on the first biometric identity; prompt the first party to provide a second biometric sample; verify the first personal identification information and the second biometric sample using the first biometric identity; create a first verification based on verifying the first personal identification information and the second biometric sample; and persistently mark an electronic record of the transaction based on the first verification.

According to another aspect of the present disclosure, a method for verifying an identity includes receiving, at a system comprising a memory that stores instructions and a processor configured to execute the instructions, a first request to register an identity for a first party; prompting the first party to provide first personal identification information and a first biometric sample; persistently associating the first personal identification information with the first biometric sample as a first biometric identity; receiving a second request to complete a transaction with an electronic signature of the first party based on the first biometric identity; prompting the first party to provide a second biometric sample; verifying the first personal identification information and the second biometric sample using the first biometric identity; creating a first verification based on verifying the first personal identification information and the second biometric sample; and persistently marking an electronic record of the transaction based on the first verification.

A tangible, non-transitory computer-readable medium stores instructions. When executed by a processor, the instructions cause a system to: receive a first request to register an identity for a first party; prompt the first party to provide first personal identification information and a first biometric sample; persistently associate the first personal identification information with the first biometric sample as a first biometric identity; receive a second request to complete a transaction with an electronic signature of the first party based on the first biometric identity; prompt the first party to provide a second biometric sample; verify the first personal identification information and the second biometric sample using the first biometric identity; create a first verification based on verifying the first personal identification information and the second biometric sample; and persistently mark an electronic record of the transaction based on the first verification.

A controller for verifying an identity includes a memory that stores instructions; and a processor that executes the instructions. When executed by the processor, the instructions cause a system to receive a first request to register an identity for a first party; prompt the first party to provide first personal identification information and a first biometric sample; persistently associate the first personal identification information with the first biometric sample as a first biometric identity; receive a second request to complete a transaction with an electronic signature of the first party based on the first biometric identity; prompt the first party to provide a second biometric sample; verify the first personal identification information and the second biometric sample using the first biometric identity; create a first verification based on verifying the first personal identification information and the second biometric sample; and persistently mark an electronic record of the transaction based on the first verification.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 illustrates a system for identification verification, in accordance with a representative embodiment.

FIG. 2 illustrates another system for identification verification, in accordance with a representative embodiment.

FIG. 3 illustrates a method for identification verification, in accordance with a representative embodiment.

FIG. 4 illustrates another method for identification verification, in accordance with a representative embodiment.

FIG. 5A illustrates another method for identification verification, in accordance with a representative embodiment.

FIG. 5B illustrates another method for identification verification, in accordance with a representative embodiment.

FIG. 6 illustrates another method for identification verification, in accordance with a representative embodiment.

FIG. 7 illustrates a computer system, on which a method for identification verification is implemented, in accordance with another representative embodiment.

FIG. 8 illustrates a device for identification verification, in accordance with a representative embodiment.

### DETAILED DESCRIPTION

In the following detailed description, for the purposes of explanation and not limitation, representative embodiments disclosing specific details are set forth in order to provide a thorough understanding of embodiments according to the present teachings. However, other embodiments consistent with the present disclosure that depart from specific details disclosed herein remain within the scope of the appended claims. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. Definitions and explanations for terms herein are in addition to the technical and scientific meanings of the terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the inventive concept.

As used in the specification and appended claims, the singular forms of terms ‘a’, ‘an’ and ‘the’ are intended to include both singular and plural forms, unless the context clearly dictates otherwise. Additionally, the terms “comprises”, and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to”, “coupled to”, or “adjacent to” another element or component, it will be understood that the clement or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

The present disclosure, through one or more of its various aspects, embodiments and/or specific features or sub-components, is thus intended to bring out one or more of the advantages as specifically noted below.

As described herein, personal identification information for a party and a biometric sample from the party may be persistently associated as a biometric identity and subsequently used to create a verification for the party. The verification for the party may be used to persistently mark an electronic record of a transaction based on a request to complete the transaction with an electronic signature of the party based on the biometric identity.

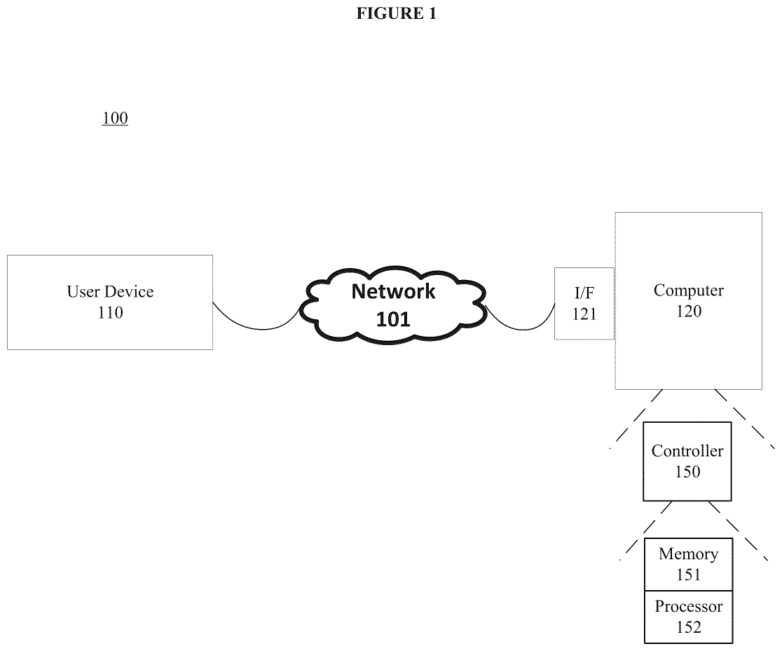

FIG. 1 illustrates a system 100 for identification verification, in accordance with a representative embodiment.

The system 100 in FIG. 1 is a system for identification verification and includes components that may be provided together or that may be distributed. The system 100 includes a user device 110 and a computer 120 that communicate over a network 101.

The network 101 may comprise any combination of one or more of a local area network and a wide area network, a wireless network and a wired network, a public network and a private network. For example, the network 101 may comprise a wireless fidelity (WiFi) network as a wireless local area network and the Internet as a wired wide area network.

The user device 110 may be, for example, a smartphone, a tablet computer, a laptop computer, a personal computer or another type of communication device used by a user.

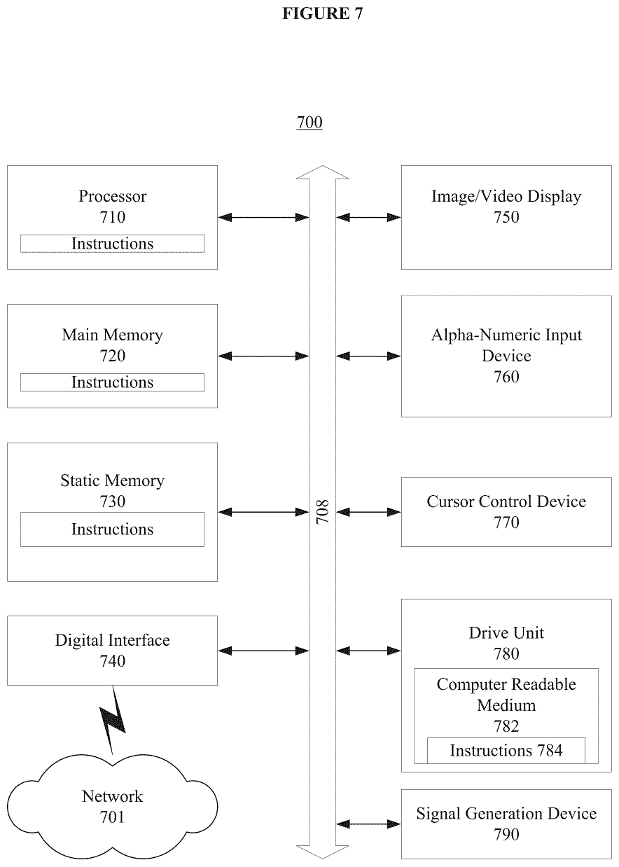

The computer 120 is representative of a single computer or a networked arrangement of computer such as in a cloud context. The computer 120 includes an interface 121 and a controller 150. The controller 150 includes at least a memory 151 that stores instructions and a processor 152 that executes the instructions. A computer that can be used to implement the computer 120 is depicted in FIG. 7, though a computer 120 may include more or fewer elements than depicted in FIG. FIG. 7.

The interface 121 allows the computer 120 to communicate with the user device 110 over the network 101. The interface 121 is representative of one or more interfaces of the computer 120, such as a first interface, a second interface, a third interface, and a fourth interface. One or more of the interfaces may include ports, disk drives, wireless antennas, or other types of receiver circuitry that connect the computer 120 to other electronic elements. One or more of the interfaces may also include user interfaces such as buttons, keys, a mouse, a microphone, a speaker, or other elements that users can use to interact with the computer 120 such as to enter instructions and receive output. The controller 150 may perform some of the operations described herein directly and may implement other operations described herein indirectly. For example, the controller 150 may indirectly control operations such as by generating and transmitting content to be displayed on a display or by generating prompts sent to the user device 110. The controller 150 may directly control other operations such as logical operations performed by the processor 152 executing instructions from the memory 151 based on input received from electronic elements and/or users via the interfaces. Accordingly, the processes implemented by the controller 150 when the processor 152 executes instructions from the memory 151 may include steps not directly performed by the controller 150.

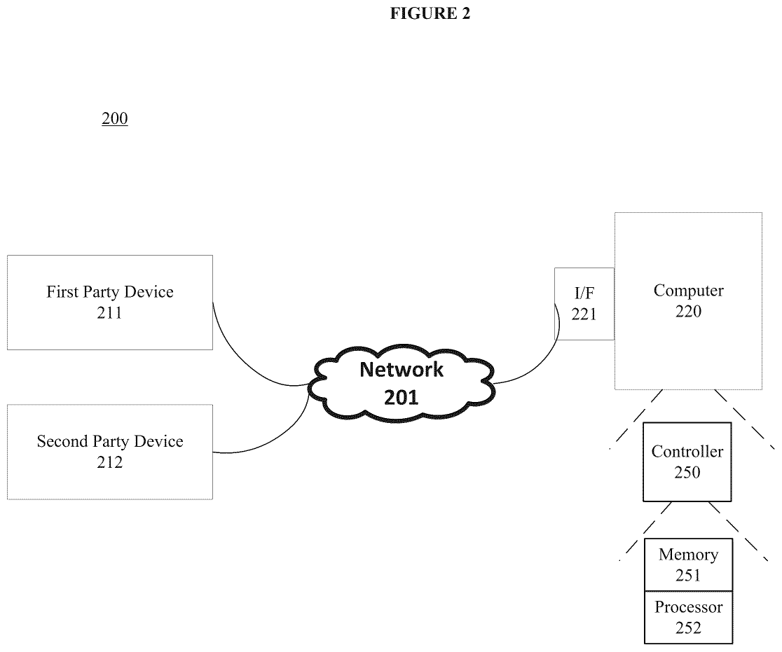

FIG. 2 illustrates another system for identification verification, in accordance with a representative embodiment.

The system 200 is a system for identification verification and includes components that may be provided together or that may be distributed. The system 200 in FIG. 2 includes a first party device 211, a second party device 212, and a computer 220 that communicate over a network 201.

The first party device 211 and the second party device 212 may be, for example, smartphones, tablet computers, laptop computers, personal computers, or other types of communication devices used by users.

The computer 220 is representative of a single computer or a networked arrangement of computer such as in a cloud context. The computer 220 again includes an interface 221 and a controller 250 as in FIG. 1, and descriptions thereof will not be repeated. The controller 250 may perform some of the operations described herein directly and may implement other operations described herein indirectly. For example, the controller 250 may indirectly control operations such as by generating and transmitting content to be displayed on a display or by generating prompts sent to first party device 211 and/or the second party device 212. The controller 250 may directly control other operations such as logical operations performed by the processor 252 executing instructions from the memory 251 based on input received from electronic elements and/or users via the interfaces. Accordingly, the processes implemented by the controller 250 when the processor 252 executes instructions from the memory 251 may include steps not directly performed by the controller 250.

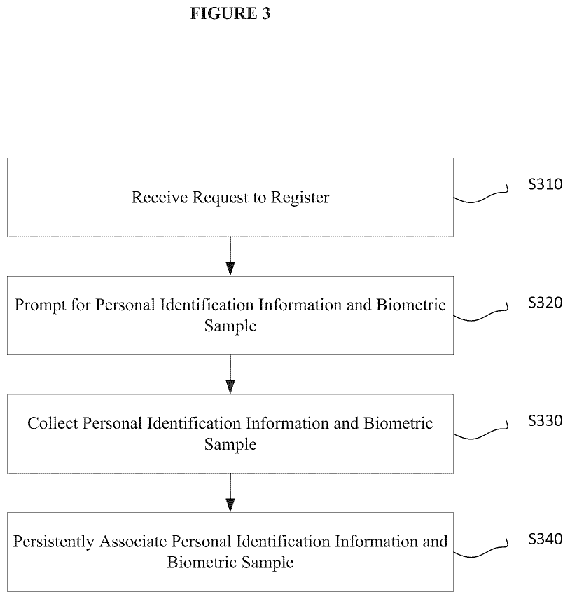

FIG. 3 illustrates a method for identification verification, in accordance with a representative embodiment.

The method of FIG. 3 may be performed by the system 100 including the computer 120 with the controller 150 and/or by the system 200 including the computer 220 with the controller 250.

At S310, a request is received to register a user using the user device 110 or a party using the first party device 211. Registration may be accomplished by a user or party visiting a website that offers the registration, and/or by downloading an application that offers the registration. For example, an application may be downloaded from an app store. In some embodiments, the website or app may not be specifically dedicated to the identification verification described herein, and instead may offer the identification verification as a secondary service that supports the primary service offered by the website or app. Registration may be performed by providing a user or party fields to populate with personal identification information, and a prompt that allows the user or party to input a fingerprint, a picture, a voice sample, or another type of biometric sample. The biometric sample may be input via a microphone or camera, for example.

At S320, the user or the party is prompted for personal identification information and a biometric sample. The prompt may be sent from the computer 120 to the user device 110 or from the computer 220 to the first party device 211. The biometric sample prompted at S320 may comprise a first biometric sample. The first biometric sample may comprise a voice sample, an image of a face, a scan of an eye, a fingerprint from a specified finger, or any other biometric sample that may be collected using a user device 110. The personal identification information may include at least one of a name, a government issued identification, a birthday, demographic or historical information, or other types of personal information that can be used to identify a specific user or party.

At S330, the prompted personal identification information and biometric sample are collected from the user or the party. The prompted personal identification information and biometric sample may be received at the computer 120 or the computer 220. The biometric sample collected at S330 may comprise a voice sample or a facial recognition sample or another type of biometric sample. The voice sample may be characterized by a range of audio markers.

At S340, the collected personal identification information and biometric sample are persistently associated as a biometric identity. The persistent association may be performed at the computer 120 or the computer 220. As used herein, the word persistent refers to a status that remains after the session in which the status is obtained. A persistent association may be permanent or semi-permanent, and may be maintained by logical and/or physical restrictions that prevent the persistent association from being changed even when other non-persistent information stored on the same device may be deleted.

The biometric identity may comprise an integrated data set that includes a unique arrangement of data generated based on the biometric sample from the party. The biometric identity may include a combination of some or all of the personal identification information and the biometric sample, or may be derived from a combination of some or all of the personal identification information and the biometric sample. For example, the biometric identity may comprise a hash or another form of encryption or condensing of a combination of some or all of the personal identification information and the biometric sample. The biometric identity may be reproducible based on subsequent biometric samples from the party and some or all of the personal identification information used to generate or otherwise create the biometric identity.

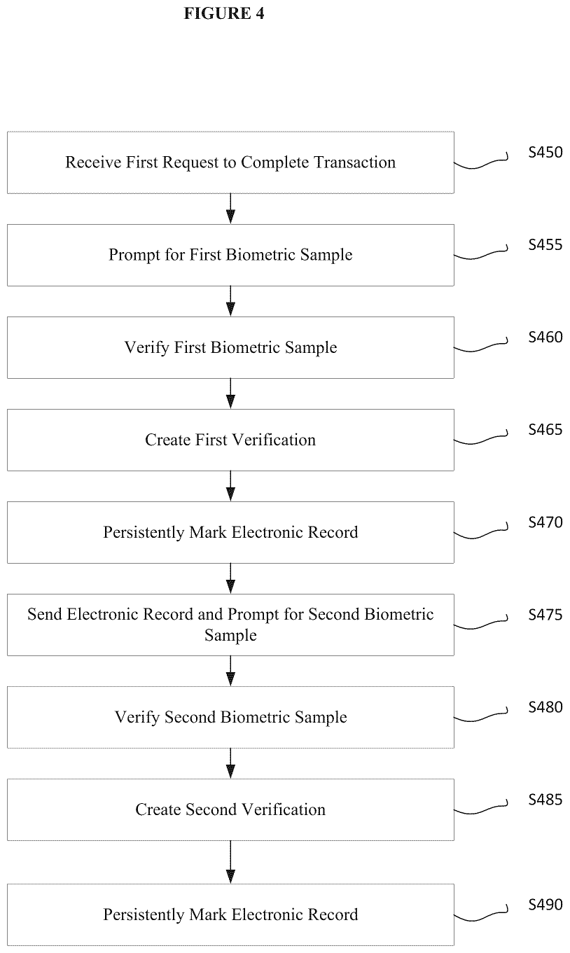

FIG. 4 illustrates another method for identification verification, in accordance with a representative embodiment.

The method of FIG. 4 may represent a dynamic process in which a first party and a second party each dynamically and persistently mark an electronic record, such as for a transaction or another type of agreement.

At S450, a first request to complete a transaction is received from the first party using the first party device 211. The first request may be received at the computer 220. The transaction is not necessarily a financial transaction or a trade of any kind. A transaction may include an agreement that does not involve an exchange of payment or goods, such as an agreement between two parties as to rules governing conduct or a relationship. The transaction may also involve more than two parties, such as when three or more parties are to agree on a matter in a transaction requiring electronic signatures from each of the three or more parties.

At S455, the first party is prompted for a first biometric sample. The prompt may comprise an audible prompt, a visual prompt provided via a graphical user interface, and/or a combination of audible and visual prompt. The prompt may be sent from the computer 220 to the first party device 211. The first biometric sample may comprise a voice sample or a facial recognition sample. The voice sample may be characterized by a range of audio markers. In some embodiments, the prompt at S455 may also be for first personal identification information, such as to match with previous personal identification information collected from the first party in a registration process as in FIG. 3.

The first biometric sample collected at S455 is not necessarily the first biometric sample collected from the first party. Rather, the first biometric sample collected based on the prompt at S455 may be compared with a previous biometric sample or a derivation of a previous biometric sample collected in a registration process as in S330. In other words, the first biometric sample collected based on the prompt at S455 may not, in fact, be the first biometric sample collected from the user or party using the first party device 211. Rather, the first biometric sample should be comparable with an earlier biometric sample collected from the same user or party, and persistently associated with personal identification information for the user or party as in the method of FIG. 3.

At S460, the first biometric sample is verified. The party using the first party device 211 may provide the first biometric sample based on the prompt at S455. The party using the first party device 211 may be logged in to an application on the first party device 211, so the identity of the party using the first party device 211 may be known or at least presumed from being logged in. Alternatively, the party using the first party device 211 may dynamically provide the first personal identification information if so prompted at S455. The first biometric sample may be compared with a biometric identity established for the party using the first party device 211 as at S340.

At S465, a first verification is created for the party using the first party device 211, and at S470, an electronic record may be persistently marked based on the first verification for the party using the first party device 211. The electronic record may comprise a data set such as a formatted document memorializing a transaction formatted in a specific format. The first verification or a unique representation of the first verification may be persistently marked as data in the electronic record. In some embodiments, the first verification may be a precursor to the persistent marking, and the electronic record may be persistently marked with a digital watermark or other digital representation based on the first verification. In other words, the persistent marketing may be with the first verification or a unique representation of the first verification, but may also or alternatively be in another form such as when the first verification is used as a precursor to persistent marking with a digital watermark or other digital representation.

The first verification may be created at S465 based on the biometric identity for the party using the first party device 211. For example, the first verification may be created via a hash function so as to be derived at least partly from the biometric identity for the party which, in turn, is generated based on personal identification information and a biometric sample for the party. Alternatively, the first verification may be entirely independent of any biometric or personal information of the party. The persistent marking at S470 may be provided via a hash tied at least in part to the biometric identity and personal information of the party using the first party device 211. The biometric sample is not tied to a response from a verification engine to a mobile device insofar as the verification engine may return a numeric value, such as between 0 and 100, and would not return the biometric sample tied to the number value.

At S475, the electronic record is sent to the second party using the second party device 212, and the party using the second party device 212 is prompted for a second personal identification and a second biometric sample. The prompt may comprise an audible prompt, a visual prompt provided via a graphical user interface, and/or a combination of audible and visual prompt. The prompt may be sent from the computer 220 to the second party device 212. The second biometric sample may comprise a voice sample or a facial recognition sample. The voice sample may comprise a range of audio markers. In some embodiments, the prompt at S475 may also be for second personal identification information, such as to match with previous personal identification information collected from the second party in a registration process as in FIG. 3.

The second biometric sample collected at S475 is not necessarily the second or the first biometric sample collected from the second party. Rather, the second biometric sample collected based on the prompt at S475 may be compared with a previous biometric sample or a derivation of a previous biometric sample collected in a registration process as in S330. In other words, the second biometric sample collected based on the prompt at S475 may not, in fact, be the first biometric sample or the second biometric sample collected from the user or party using the second party device 212. Rather, the second biometric sample should be comparable with an earlier biometric sample collected from the same user or party, and persistently associated with personal identification information for the user or party as in the method of FIG. 3.

At S480, the second biometric sample is verified. The party using the second party device 212 may provide the second biometric sample based on the prompt at S475. The party using the second party device 212 may be logged in to an application on the second party device 212, so the identity of the party using the second party device 212 may be known or at least presumed from being logged in. Alternatively, the party using the second party device 212 may dynamically provide the second personal identification information when so prompted at S475. The second biometric sample may be compared with a biometric identity established for the party using the second party device 212 as at S340.

At S485, a second verification is created for the party using the second party device 212, and at S490, the electronic record may be persistently marked with the second verification for the party using the second party device 212. The second verification or a unique representation of the second verification may be persistently marked as data in the electronic record. In some embodiments, the second verification may be a precursor to the persistent marking, and the electronic record may be persistently marked with a digital watermark or other digital representation based on the second verification. In other words, the persistent marketing may be with the second verification or a unique representation of the second verification, but may also or alternatively be in another form such as when the second verification is used as a precursor to persistent marking with a digital watermark or other digital representation.

The method of FIG. 4 may include the first party using the first party device 211 initiating the transaction and sending the request at S450 to the computer 220. Alternatively, the method of FIG. 4 may include the second party using the second party device 212 initiating the transaction and sending the request at S450 to the computer 220. Although not shown in FIG. 4, both the first party and the second party may be registered according to the method of FIG. 3. Registration of the second party using the second party device 212 may includes the computer 220 receiving a third request to register an identity for the second party; prompting the second party to provide second personal identification information and a third biometric sample; and persistently associating the second personal identification information with the third biometric sample as a second biometric identity. Subsequently, a fourth request to complete the transaction with an electronic signature of the second party based on the second biometric identity may be received from either the first party device 211 or the second party device 212. The computer 220 may then prompt the second party to provide the second personal identification information and a fourth biometric sample at S475, verify the second personal identification information and the fourth biometric sample using the second biometric identity at S480, create a second verification at S485 based on verifying the second personal identification information and the fourth biometric sample, and persistently mark the electronic record of the transaction with the second verification at S490.

After S490, the process of FIG. 4 may end, or one or both parties may be notified that the transaction is complete. For example, one or both parties may be sent a copy of the electronic record with both persistent marks from S470 and S490 for their records.

In FIG. 4, the various biometric samples may comprise voice samples and/or facial recognition samples, or combinations of different types of facial recognition samples. Additionally, as set forth above, in FIG. 4, the first biometric sample is not necessarily the first biometric sample collected from the first party using the first party device 211. Instead, the first party may be pre-registered with a prior biometric sample (e.g., a first biometric sample), and the second party may be pre-registered with a prior biometric sample (e.g., a second biometric sample), and the biometric sample collected based on the prompt at S455 may therefore be a third biometric sample and the biometric sample collected based on the prompt at S475 may therefore be a fourth biometric sample. In other words, it will be understood that, although the terms first, second, third etc. may be used herein to describe biometric samples, users and parties herein, these biometric samples, users and parties should not be limited by these terms. These terms are only used to logically distinguish biometric samples, users and parties from other biometric samples, users and parties. Thus, a first biometric sample discussed herein could be termed a second biometric sample or third biometric sample without departing from the teachings of the inventive concept(s) described herein.

A variety of audio markers may be included in a range of audio markers in a given audio clip. A trained machine learning model may be applied to analyze a given audio clip. Examples of such audio markers include characteristics such as phonetics, spectral characteristics, formants, prosody, mel-frequency ceptstral coefficient (MFCC), fundamental frequency, voice quality, speaker-specific articulation patterns speaker diarization, pattern matching, and more, some of which are described next.

Phonetics refers to the study of physical sounds of human speech. In the context of voice-based identity matching, phonetics may involve analyzing specific phonetic properties and characteristics of a speaker's voice, such as the pronunciation of individual sounds, phoneme durations, and intonation patterns.

Spectral Analysis involves examining the frequency content of a voice signal. By analyzing the distribution and intensity of different frequency components in a voice clip, a trained machine learning model may extract relevant features for voice-based identity matching. Spectral analysis techniques include Fourier transforms including fast fourier transforms (FFTs) which are commonly used for spectral analysis.

Formants are the resonant frequencies produced by the vocal tract during speech. Formants are essential for distinguishing different vowel sounds and are often used as features in voice recognition systems. Formant analysis involves identifying and measuring the frequencies of the prominent formants in a voice signal.

Prosody refers to the rhythm, pitch, and intonation patterns in speech. Prosody includes features such as stress, pitch contours, timing, and rhythm of speech. Prosodic analysis may be important for capturing the vocal inflections and variations that contribute to a speaker's individual identity.

Mel-frequency cepstral coefficients (MFCC) are a commonly used feature extraction technique in voice recognition tasks. Mel-frequency cepstral coefficients represent the spectral characteristics of a voice signal by calculating the Mel-scale frequency domain filter bank auditory energies and applying a discrete cosine transform. Mel-frequency cepstral coefficients capture relevant information about the shape and distribution of the spectral envelope of the voice.

The fundamental frequency (F0), also known as F0 or pitch, represents the perceived pitch of a voice signal. The fundamental frequency provides information about the vocal characteristics of a speaker and can be used as a feature for voice-based identity matching. Fundamental frequency analysis involves estimating the fundamental frequency contour of a voice clip.

Voice quality refers to the subjective characteristics of a person's voice, such as breathiness, hoarseness, or nasality. Voice quality is influenced by the physiology and anatomy of the vocal apparatus. Analyzing voice quality involves extracting relevant features related to the unique vocal characteristics of a speaker.

Speaker-specific articulation patterns refer to the unique way in which each individual articulating sounds, which can be captured as speaker-specific articulation patterns. These patterns include aspects such as the speed of speech, pauses, and speech disfluencies, which can contribute to the individuality of a speaker's voice.

Speaker diarization is the process of segmenting or otherwise partitioning an audio recording into individual speaker turns. Speaker diarization helps identify and separate different speakers in a voice clip, which is valuable for voice-based identity matching. Speaker diarization algorithms utilize techniques such as speaker clustering, voice activity detection, and speaker turn boundary detection.

Pattern matching techniques involve comparing and matching voice patterns extracted from a target voice clip with reference voice patterns in a database. These patterns can include spectral features, MFCCs, formant frequencies, or any other relevant features extracted from the voice data. Pattern matching algorithms, such as dynamic time warping or Gaussian mixture models, are often used for voice-based identity matching.

Although the methods of FIG. 3 and FIG. 4 are primarily described in the context or registration and subsequent verification for marking of electronic records, it should be clear that the verification taught herein is not restricted to use of marking of electronic records. For example, verification may be used to authenticate identity of an individual for a variety of purposes such as voting, passage through a controlled entrance, access to restricted content, or a variety of other uses in which verification described herein may be useful.

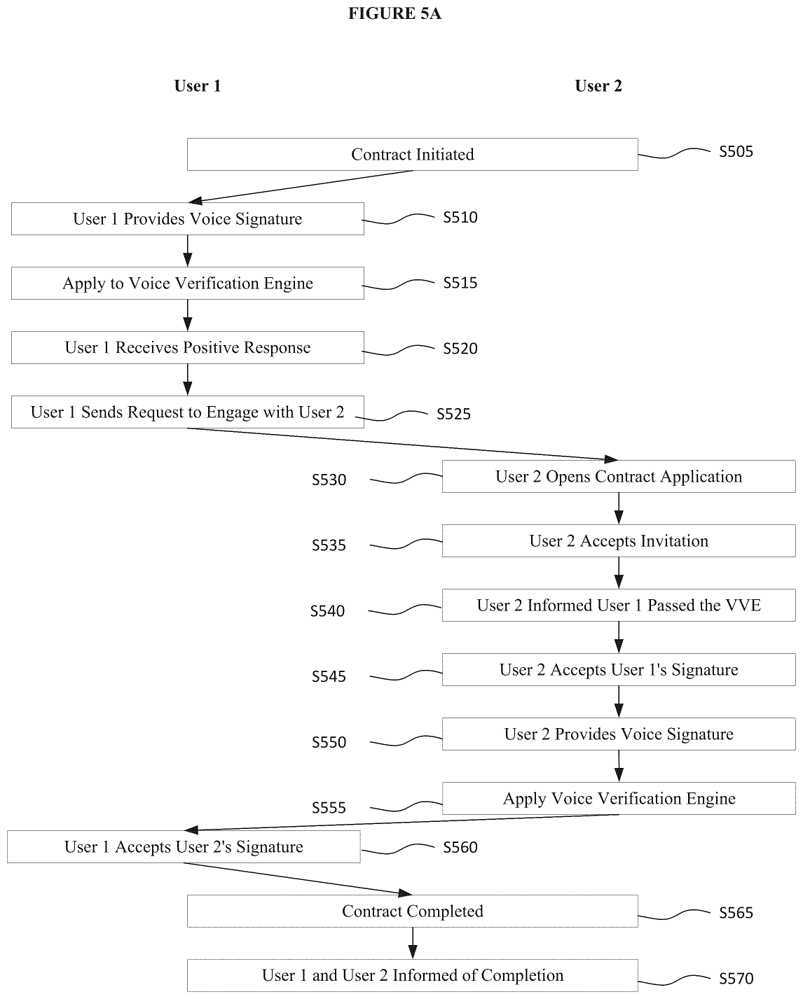

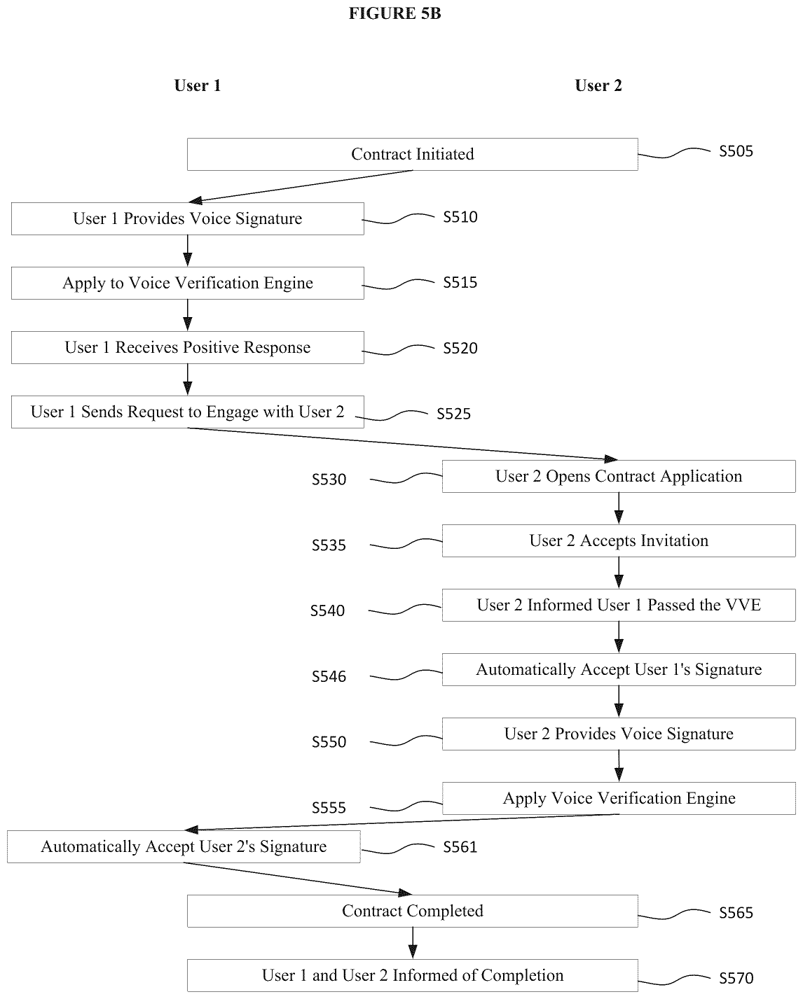

FIG. 5A illustrates another method for identification verification, in accordance with a representative embodiment.

FIG. 5A illustrates another flow involving two users, i.e., user 1 and user 2. At S505, user 1 and user 2 initiate a contract. For example, user 1 and user 2 may use a third-party smartphone app or website to initiate an agreement to buy or sell a product or service.

At S510, user 1 provides a voice signature. User 1 may provide the voice signature to the first party device 211.

At S515, a voice verification engine is applied to the voice signature from user 1. The voice verification engine may be implemented as a set of software instructions on the first party device 211 or the computer 220.

At S520, user 1 receives a positive response based on applying the voice verification engine.

At S525, user 1 sends a request to engage with user 2. The request may be sent to the computer 220 and/or directly to the second party device 212.

At S530, user 2 opens a contract application on the second party device 212.

At S535, user 2 accepts the invitation sent at S522 by user 1.

At S540, user 2 is informed that user 1 passed the verification by the voice verification engine at S515.

At S545, user 2 accepts user 1's voice signature.

At S550, user 2 provides a voice signature.

At S555, a voice verification engine is applied to the voice signature from user 2. The voice verification engine may be implemented as a set of software instructions on the second party device 212 or the computer 220.

At S560, user 1 accepts user 2's voice signature.

At S565, the contract is completed.

At S570, user 1 and user 2 are each informed of completion of the contract.

FIG. 5B illustrates another method for identification verification, in accordance with a representative embodiment.

FIG. 5B is similar to FIG. 5A, except that the user acceptances of signatures at S545 and S560 in FIG. 5A is now replaced with automated acceptances of signatures at S546 and S561. The voice verification engine may have a threshold for acceptance, and may apply a trained machine learning model to the voice signatures to automatically determined whether or not to accept the voice signatures at S546 and S561. In some embodiments, the voice verification engine or the trained machine learning model may output a result that is checked by another program to determine whether the voice signatures can be automatically accepted. The other program may be a hosted function that is or includes an application programming interface.

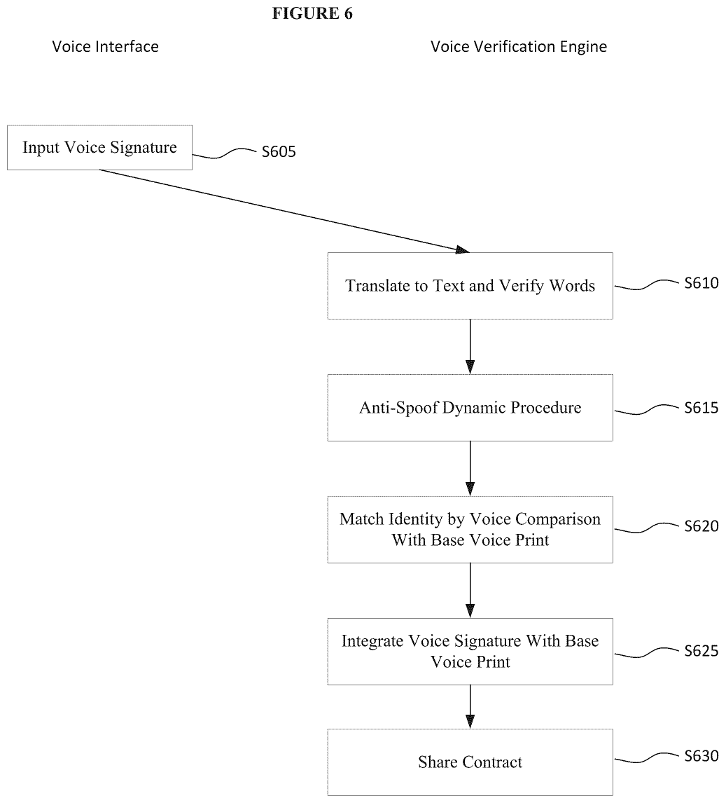

FIG. 6 illustrates another method for identification verification, in accordance with a representative embodiment.

In FIG. 6, a voice interface and a voice verification engine (VVE) may comprise separate circuit elements and/or software programs of user device or party device described herein.

At S605, the voice interface accepts an input voice signature. For example, the voice interface may include a microphone configured to accept a voice sample as a biometric sample from a user or party. The voice sample may be prompted from a speaker or a graphical user interface.

At S610, the voice verification engine translates the voice signature to text and verifies the words in the voice signature.

At S615, an anti-spoof dynamic procedure is performed, such as by dynamically generating a randomized code and prompting the user or party to repeat the randomized code as a voice signature. The anti-spoof dynamic procedure may involve generating text that is dynamically varied for each prompt to any party. The prompt for the anti-spoof dynamic procedure may be provided from a speaker or graphical user interface. Additionally, the input from the user or party may be provided audibly to a microphone or physically via an interactive touchscreen or keypad.

At S620, identity of the user or party is matched by voice comparison of the input voice signature with a base voice print. The matching may involve generating a confidence score based on the similarities and dissimilarities between the input voice signature and base voice print. A confidence score may be compared to a predetermined threshold to determine whether the identity is verified or not. The predetermined threshold may vary for users and parties based on demographic characteristics such as age, gender, the amount of time elapsed between when the base voice print is generated and when the input voice signature is accepted, and more. In some embodiments, the user or party, or a supervisor or adult responsible for the user or party, may be allowed to set or adjust the predetermined threshold.

At S625, the voice signature may be integrated with the base voice print. Integration refers to the process of taking a biometric sample that successfully passed a voice verification engine and combining it with the biometric identity. The biometric identity may be created based on 30 seconds of high quality speech data. 30 seconds of audio may be the minimum needed to create an identity profile, though prompting the user for 60 seconds of audio may provide a stronger identity profile because there is more data to extract from the voice sample. Therefore, when a biometric sample is determined to be of a high enough quality the biometric sample may be added to the first biometric sample and create a ‘new’ biometric identity that is based on a larger total audio sample including the first biometric sample and now, the second/third/fourth sample(s). A positive response from the voice verification engine does not immediately trigger a “merge” of the samples, however, a higher threshold may be required for a merge than for a ‘verification’ of a sample. For example, a new sample may have a high signal to noise ratio which can be used to confirm identity of the individual, but the quality of the audio clip may not be high enough to warrant integration/merge as it may actually decrease the ability of the voice verification engine to match identity in the future.

At S630, a contract is shared based on the match at S620. For example, the contract may be emailed to a first party and a second party, or may be shared via an application installed on either or both of the first party device 211 and/or the second party device 212.

FIG. 7 illustrates a computer system, on which a method for identification verification is implemented, in accordance with another representative embodiment.

Referring to FIG. 7, the computer system 700 includes a set of software instructions that can be executed to cause the computer system 700 to perform any of the methods or computer-based functions disclosed herein. The computer system 700 may operate as a standalone device or may be connected, for example, using a network 701, to other computer systems or peripheral devices. In embodiments, a computer system 700 performs logical processing based on digital signals received via an analog-to-digital converter.

In a networked deployment, the computer system 700 operates in the capacity of a server or as a client user computer in a server-client user network environment, or as a peer computer system in a peer-to-peer (or distributed) network environment. The computer system 700 can also be implemented as or incorporated into various devices, such as a workstation that includes a controller, a stationary computer, a mobile computer, a personal computer (PC), a laptop computer, a tablet computer, or any other machine capable of executing a set of software instructions (sequential or otherwise) that specify actions to be taken by that machine. The computer system 700 can be incorporated as or in a device that in turn is in an integrated system that includes additional devices. In an embodiment, the computer system 700 can be implemented using electronic devices that provide voice, video or data communication. Further, while the computer system 700 is illustrated in the singular, the term “system” shall also be taken to include any collection of systems or sub-systems that individually or jointly execute a set, or multiple sets, of software instructions to perform one or more computer functions.

As illustrated in FIG. 7, the computer system 700 includes a processor 710. The processor 710 may be considered a representative example of a processor of a controller and executes instructions to implement some or all aspects of methods and processes described herein. The processor 710 is tangible and non-transitory. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The processor 710 is an article of manufacture and/or a machine component. The processor 710 is configured to execute software instructions to perform functions as described in the various embodiments herein. The processor 710 may be a general-purpose processor or may be part of an application specific integrated circuit (ASIC). The processor 710 may also be a microprocessor, a microcomputer, a processor chip, a controller, a microcontroller, a digital signal processor (DSP), a state machine, or a programmable logic device. The processor 710 may also be a logical circuit, including a programmable gate array (PGA), such as a field programmable gate array (FPGA), or another type of circuit that includes discrete gate and/or transistor logic. The processor 710 may be a central processing unit (CPU), a graphics processing unit (GPU), or both. Additionally, any processor described herein may include multiple processors, parallel processors, or both. Multiple processors may be included in, or coupled to, a single device or multiple devices.

The term “processor” as used herein encompasses an electronic component able to execute a program or machine executable instruction. References to a computing device comprising “a processor” should be interpreted to include more than one processor or processing core, as in a multi-core processor. A processor may also refer to a collection of processors within a single computer system or distributed among multiple computer systems. The term computing device should also be interpreted to include a collection or network of computing devices each including a processor or processors. Programs have software instructions performed by one or multiple processors that may be within the same computing device or which may be distributed across multiple computing devices.

The computer system 700 further includes a main memory 720 and a static memory 730, where memories in the computer system 700 communicate with each other and the processor 710 via a bus 708. Either or both of the main memory 720 and the static memory 730 may be considered representative examples of a memory of a controller, and store instructions used to implement some or all aspects of methods and processes described herein. Memories described herein are tangible storage mediums for storing data and executable software instructions and are non-transitory during the time software instructions are stored therein. As used herein, the term “non-transitory” is to be interpreted not as an eternal characteristic of a state, but as a characteristic of a state that will last for a period. The term “non-transitory” specifically disavows fleeting characteristics such as characteristics of a carrier wave or signal or other forms that exist only transitorily in any place at any time. The main memory 720 and the static memory 730 are articles of manufacture and/or machine components. The main memory 720 and the static memory 730 are computer-readable mediums from which data and executable software instructions can be read by a computer (e.g., the processor 710). Each of the main memory 720 and the static memory 730 may be implemented as one or more of random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. The memories may be volatile or non-volatile, secure and/or encrypted, unsecure and/or unencrypted.

“Memory” is an example of a computer-readable storage medium. Computer memory is any memory which is directly accessible to a processor. Examples of computer memory include, but are not limited to RAM memory, registers, and register files. References to “computer memory” or “memory” should be interpreted as possibly being multiple memories. The memory may for instance be multiple memories within the same computer system. The memory may also be multiple memories distributed amongst multiple computer systems or computing devices.

As shown, the computer system 700 further includes a video display unit 750, such as a liquid crystal display (LCD), an organic light emitting diode (OLED), a flat panel display, a solid-state display, or a cathode ray tube (CRT), for example. Additionally, the computer system 700 includes an input device 760, such as a keyboard/virtual keyboard or touch-sensitive input screen or speech input with speech recognition, and a cursor control device 770, such as a mouse or touch-sensitive input screen or pad. The computer system 700 also optionally includes a disk drive unit 780, a signal generation device 790, such as a speaker or remote control, and/or a network interface device 740.

In an embodiment, as depicted in FIG. 7, the disk drive unit 780 includes a computer-readable medium 782 in which one or more sets of software instructions 784 (software) are embedded. The sets of software instructions 784 are read from the computer-readable medium 782 to be executed by the processor 710. Further, the software instructions 784, when executed by the processor 710, perform one or more steps of the methods and processes as described herein. In an embodiment, the software instructions 784 reside all or in part within the main memory 720, the static memory 730 and/or the processor 710 during execution by the computer system 700. Further, the computer-readable medium 782 may include software instructions 784 or receive and execute software instructions 784 responsive to a propagated signal, so that a device connected to a network 701 communicates voice, video or data over the network 701. The software instructions 784 may be transmitted or received over the network 701 via the network interface device 740.

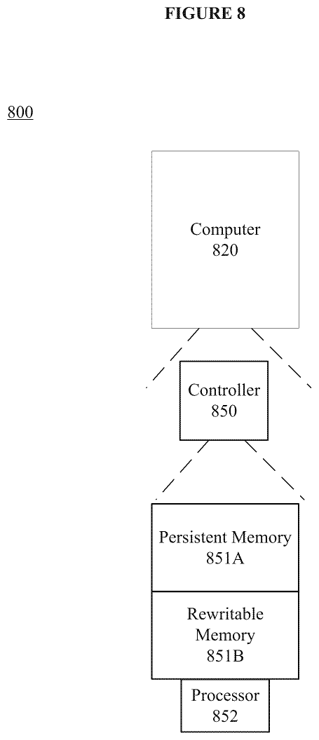

FIG. 8 illustrates a device for identification verification, in accordance with a representative embodiment.

The device 800 in FIG. 8 comprises a computer 820. The computer 820 includes a controller 850. The controller 850 includes a persistent memory 851A, a rewritable memory 851B and a processor 852. The persistent memory 851A may be used to store persistent associations between personal identification information biometric samples as biometric identities. The persistent memory 851A may be expandable so that additional pages, rows and/or columns may be marked read-only. The persistence of the persistent associations described herein may be permanent or semi-permanent. When the persistence is permanent, associations stored in the persistent memory 851A may not be erased. When the persistence is semi-permanent, associations stored in the persistent memory 851A may only be erased based upon a heightened logical authorization, such as an administrative authorization higher than what is otherwise required to erase data in the rewritable memory 851B. In some embodiments, the instructions guiding when data in the persistent memory 851A may be erased may also be stored in the persistent memory 851A.

In an embodiment, dedicated hardware implementations, such as application-specific integrated circuits (ASICs), field programmable gate arrays (FPGAs), programmable logic arrays and other hardware components, are constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing may implement one or more of the methods or functionalities as described herein, and a processor described herein may be used to support a virtual processing environment.

Accordingly, identification verification enables verification of a party by persistently associating personal identification information for the party and a biometric sample from the party as a biometric identity. The personal identification information and the biometric sample persistently associated as a biometric identity may be subsequently used to create a verification for the party. The verification for the party may be used to persistently mark an electronic record of a transaction based on a request to complete the transaction with an electronic signature of the party based on the biometric identity. As set forth also above, it should be clear that the verification taught herein is not restricted to use of marking of electronic records. For example, verification may be used to authenticate identity of an individual for a variety of purposes such as voting, passage through a controlled entrance, access to restricted content, or a variety of other uses in which verification described herein may be useful.

Although identification verification has been described with reference to several exemplary embodiments, it is understood that the words that have been used are words of description and illustration, rather than words of limitation. Changes may be made within the purview of the appended claims, as presently stated and as amended, without departing from the scope and spirit of identification verification in its aspects. Although identification verification has been described with reference to particular means, materials and embodiments, identification verification is not intended to be limited to the particulars disclosed; rather identification verification extends to all functionally equivalent structures, methods, and uses such as are within the scope of the appended claims.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to practice the concepts described in the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A system for verifying an identity, comprising:
a memory that stores instructions; and
a processor that executes the instructions, wherein, when executed by the processor, the instructions cause the system to:
receive a first request to register an identity for a first party;
prompt the first party to provide first personal identification information and a first biometric sample;
persistently associate the first personal identification information with the first biometric sample as a first biometric identity;
receive a second request to complete a transaction with an electronic signature of the first party based on the first biometric identity;
prompt the first party to provide a second biometric sample;
verify the first personal identification information and the second biometric sample using the first biometric identity;
create a first verification based on verifying the first personal identification information and the second biometric sample; and
persistently mark an electronic record of the transaction based on the first verification.

2. The system of claim 1, wherein the first party initiates the transaction and the second request is received from the first party.

3. The system of claim 1, wherein a second party initiates the transaction and the second request is received from the second party.

4. The system of claim 3, wherein the instructions cause the system further to:
receive a third request to register an identity for a second party;
prompt the second party to provide second personal identification information and a third biometric sample;
persistently associate the second personal identification information with the third biometric sample as a second biometric identity;
receive a fourth request to complete the transaction with an electronic signature of the second party based on the second biometric identity;
prompt the second party to provide the second personal identification information and a fourth biometric sample;
verify the second personal identification information and the fourth biometric sample using the second biometric identity;
create a second verification based on verifying the second personal identification information and the fourth biometric sample; and
persistently mark the electronic record of the transaction with the second verification.

5. The system of claim 4, wherein the first biometric sample, the second biometric sample, the third biometric sample and the fourth biometric sample are voice samples.

6. The system of claim 4, wherein the first biometric sample, the second biometric sample, the third biometric sample and the fourth biometric sample are biometric samples.

7. The system of claim 4, wherein the first biometric sample, the second biometric sample, the third biometric sample and the fourth biometric sample comprise combinations of different types of biometric samples.

8. The system of claim 1, wherein text in each prompt to the first party is dynamically varied.

9. The system of claim 8, wherein the instructions cause the system further to:
compare speech in the second biometric sample with text used to prompt the first party to provide the first personal identification information and the second biometric sample.

10. The system of claim 1, wherein the second biometric sample comprises a voice sample that includes a range of audio markers.

11. A method for verifying an identity, comprising:
receiving, at a system comprising a memory that stores instructions and a processor configured to execute the instructions, a first request to register an identity for a first party;
prompting the first party to provide first personal identification information and a first biometric sample;
persistently associating the first personal identification information with the first biometric sample as a first biometric identity;
receiving a second request to complete a transaction with an electronic signature of the first party based on the first biometric identity;
prompting the first party to provide a second biometric sample;
verifying the first personal identification information and the second biometric sample using the first biometric identity;
creating a first verification based on verifying the first personal identification information and the second biometric sample; and
persistently marking an electronic record of the transaction based on the first verification.

12. The method of claim 11, wherein the first party initiates the transaction and the second request is received from the first party.

13. The method of claim 11, wherein a second party initiates the transaction and the second request is received from the second party.

14. The method of claim 13, further comprising:
receiving a third request to register an identity for a second party;
prompting the second party to provide second personal identification information and a third biometric sample;
persistently associating the second personal identification information with the third biometric sample as a second biometric identity;
receiving a fourth request to complete the transaction with an electronic signature of the second party based on the second biometric identity;
prompting the second party to provide the second personal identification information and a fourth biometric sample;
verifying the second personal identification information and the fourth biometric sample using the second biometric identity;
creating a second verification based on verifying the second personal identification and the fourth biometric sample; and
persistently marking the electronic record of the transaction with the second verification.

15. The method of claim 14, wherein the first biometric sample, the second biometric sample, the third biometric sample and the fourth biometric sample are voice samples.

16. The method of claim 14, wherein the first biometric sample, the second biometric sample, the third biometric sample and the fourth biometric sample comprise combinations of different types of biometric samples.

17. The method of claim 11, wherein text in each prompt to the first party is dynamically varied.

18. The method of claim 17, further comprising:
comparing speech in the second biometric sample with text used to prompt the first party to provide the first personal identification information and the second biometric sample.

19. The method of claim 11, wherein the second biometric sample comprises a voice sample that includes a range of audio markers.

20. A controller for verifying an identity, comprising:
a memory that stores instructions; and
a processor that executes the instructions, wherein, when executed by the processor, the instructions cause the controller to:
receive a first request to register an identity for a first party;
prompt the first party to provide first personal identification information and a first biometric sample;
persistently associate the first personal identification information with the first biometric sample as a first biometric identity;
receive a second request to complete a transaction with an electronic signature of the first party based on the first biometric identity;
prompt the first party to provide the first personal identification information and a second biometric sample;
verify the first personal identification information and the second biometric sample using the first biometric identity;
create a first verification based on verifying the first personal identification information and the second biometric sample; and
persistently mark an electronic record of the transaction based on the first verification.
